(19) United States
(12) Patent Application Publication
(10) Pub. No.: US 2025/0298949 A1
(43) Pub. Date: Sep. 25, 2025

(54) AREA EFFICIENT ASYNCHRONOUS CIRCUIT GENERATOR

(71) Applicant: University of Cincinnati, Cincinnati, OH (US)

(72) Inventor: John M. Emmert, Dayton, OH (US)

(73) Assignee: University of Cincinnati, Cincinnati, OH (US)

(21) Appl. No.: 18/868,876

(22) PCT Filed: May 26, 2023
(86) PCT No.: PCT/US2023/023691

§ 371 Date: Nov. 25, 2024

Related U.S. Application Data
(60) Provisional application No. 63/346,711, filed on May 27, 2022.

(51) Int. Cl. G06F 30/327

(52) U.S. Cl. CPC G06F 30/327

(57) ABSTRACT

An apparatus may comprise a controller programmed to receive information about a synchronized digital circuit comprising a plurality of Boolean gates, determine a critical path through each synchronized, combination subcircuit block of the digital circuit, identify a first set of Boolean gates among the plurality of Boolean gates positioned in the critical path, determine a hybrid equivalent gate for each Boolean gate among the first set of Boolean gates, wherein the hybrid equivalent gate has a synchronous input, a dual-rail asynchronous input, and a dual-rail output, and generate a modified digital circuit by replacing each Boolean gate among the first set of Boolean gates with a corresponding hybrid equivalent gate.

### CROSS REFERENCE TO RELATED APPLICATION

This application claims priority to U.S. Provisional Application Ser. No. 63/346,711, filed May 27, 2022, the entire contents of which are incorporated herein by reference.

### FEDERALLY SPONSORED RESEARCH STATEMENT

The present invention was made with Government support under Contract No. 1916722 awarded by the National Science Foundation. The U.S. Government has certain rights in the invention.

### TECHNICAL FIELD

The present specification relates to asynchronous circuit design, and more specifically, to an area efficient asynchronous circuit generator.

### BACKGROUND

Most integrated circuit (IC) designs are synchronous in nature and utilize a global clock to ensure that data simultaneously arrives at the inputs of combinational processing blocks. The faster the clock operates, the faster the IC can operate, thereby increasing its performance. However, many mixed-signal ICs also utilize analog and radio frequency (RF) components. When a synchronous IC includes analog and RF components, the digital clock signal triggers synchronized switching of the transistors in the combinational logic gates. This, in turn, causes large power spikes that may propagate through the circuit as digital noise, which may increase the noise floor for the analog and RF components, thereby reducing the signal-to-noise ratio (SNR) for these components, which may decrease their performance. In addition, the synchronized power draw of the combinational processing blocks or synchronous ICs may make them vulnerable to side channel attacks, due to predictable or timed data processing, that can expose sensitive data.

As such, in order to increase the SNR of mixed-signal ICs and reduce the vulnerability of side chain attacks, asynchronous circuits may be utilized. One method of generating asynchronous circuits is the use of null convention logic (NCL) gates. However, the use of NCL gates may significantly increase the size of asynchronous circuits compared to synchronous circuits. Accordingly, an improved method of generating asynchronous circuits is desired.

### SUMMARY

In an embodiment, an apparatus may include a controller programmed to receive information about a synchronized digital circuit comprising a plurality of Boolean gates, determine a critical path through each synchronized, combination subcircuit block of the digital circuit, identify a first set of Boolean gates among the plurality of Boolean gates positioned in the critical path, determine a hybrid equivalent gate for each Boolean gate among the first set of Boolean gates, wherein a hybrid equivalent gate has a synchronous input, a dual-rail asynchronous input, and a dual-rail output, and generate a modified digital circuit by replacing each Boolean gate among the first set of Boolean gates with a corresponding hybrid equivalent gate.

In another embodiment, a method may include receiving information about a synchronized digital circuit comprising a plurality of Boolean gates, determining a critical path through each synchronized, combination subcircuit block of the digital circuit, identifying a first set of Boolean gates among the plurality of Boolean gates positioned in the critical path, determining a hybrid equivalent gate for each Boolean gate among the first set of Boolean gates, wherein a hybrid equivalent gate has a synchronous input, a dual-rail asynchronous input, and a dual-rail output, and generating a modified digital circuit by replacing each Boolean gate among the first set of Boolean gates with a corresponding hybrid equivalent gate.

In another embodiment a digital circuit may comprise a plurality of Boolean gate. Each gate among a first set of Boolean gates along a critical path through each synchronized combination subcircuit block of the digital circuit may comprise a hybrid equivalent gate. The hybrid equivalent gate may have a synchronous input, a dual-rail input, and a dual-rail output.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts an example NAND gate, according to one or more embodiments shown and described herein;

FIG. 1B schematically depicts a circuit diagram of the NAND gate of FIG. 1, according to one or more embodiments shown and described herein;

FIG. 2A schematically depicts a null convention logic equivalent NAND gate, according to one or more embodiments shown and described herein;

FIG. 2B schematically depicts a subcircuit for a low output of the NAND gate of FIG. 2A, according to one or more embodiments shown and described herein;

FIG. 2C schematically depicts a subcircuit for a high output of the NAND gate of FIG. 2A, according to one or more embodiments shown and described herein;

FIG. 3 depicts a schematic diagram of a computing device, according to one or more embodiments shown and described herein;

FIG. 4 depicts a schematic diagram of the memory modules of the computing device of FIG. 3, according to one or more embodiments shown and described herein;

FIG. 5 schematically depicts a critical path through a digital circuit, according to one or more embodiments shown and described herein;

FIG. 6A schematically depicts an example OR gate, according to one or more embodiments shown and described herein;

FIG. 6B schematically depicts a circuit diagram of the OR gate of FIG. 6A, according to one or more embodiments shown and described herein;

FIG. 7A schematically depicts a null convention logic equivalent OR gate, according to one or more embodiments shown and described herein;

FIG. 7B schematically depicts a subcircuit for a high output of the OR gate of FIG. 7A, according to one or more embodiments shown and described herein;

FIG. 7C schematically depicts a subcircuit for a lower output of the OR gate of FIG. 7A, according to one or more embodiments shown and described herein;

FIG. 8A schematically depicts a hybrid OR gate, according to one or more embodiments shown and described herein;

FIG. 8B schematically depicts a subcircuit for a high output of the hybrid OR gate of FIG. 8A;

FIG. 8C schematically depicts a subcircuit for a low output of the hybrid OR gate of FIG. 8A;

FIG. 9 depicts a flowchart of a method for determining a hybrid equivalent gate, according to one or more embodiments shown and described herein;

FIG. 10 depicts a flowchart of a method for converting a synchronous circuit to an asynchronous circuit, according to one or more embodiments shown and described herein;

FIG. 11 shows a table of transistor counts for standard Boolean gates, NCL equivalent gates, and hybrid gates, according to one or more embodiments shown and described herein; and

FIG. 12 shows a table of transistor counts for standard benchmark circuits, NCL equivalent circuits, and hybrid equivalent circuits.

### DETAILED DESCRIPTION

The embodiments disclosed herein are directed to an area efficient asynchronous circuit generator. As discussed above, one way to both increase the SNR of ICs and reduce the susceptibility of ICs to side channel attacks is to convert a synchronous circuit into an asynchronous circuit. An asynchronous circuit does not utilize a clock, thereby reducing both the noise and security vulnerabilities introduced by such a clock.

One way to implement asynchronous circuits is to use NCL gates. Null Convention Logic is a symbolically complete logic, which expresses processes completely in terms of the lotic itself and inherently and conveniently expresses asynchronous digital circuits. NCL circuits operate by allowing data to flow in waves. A data wave is only processed when all incoming data is available, making it self-timed. Since data is only processed when available, no timing assumptions are required, which guarantees data sequencing and correct data arrival at the receiver under varying gate, process, and wire delays.

NCL gates are dual-rail with two separate wires for each signal. One wire represents the logic ‘0’ and one wire represents the logic ‘1’, and handshaking, rather than a clock, is used to cause the circuit components to handoff data between components at the appropriate time. Asynchronous registers and NCL logic gates allow a complete delay-insensitive design to be constructed.

Asynchronous NCL circuits are implemented using threshold gates with hysteresis. Threshold gates have two or more inputs and a single output, and are denoted by THmn, where the output of the gate is asserted or set if the gate has a valid ‘DATA’ value on m (threshold) of its n inputs. That is, when its threshold is met, its output is asserted. The output stays asserted until all inputs have transitioned back to ‘NULL’ in the reset phase, resulting in hysteresis. In addition to being clockless, NCL asynchronous circuits are also unsynchronized or distributed in time and have a low power consumption, which also help prevent side channel attacks. NCL gates are typically implemented by setting DATA to Vdd and setting NULL to Vss.

Asynchronous circuits implemented with NCL THmn gates are particularly good at mitigating potential data leak from ICs. In particular, since synchronous circuits are all clocked simultaneously, it is relatively simple for an untrusted agent to reverse engineer information from indirect measurements taken from the IC. For asynchronous circuits without a clock, this is much more difficult for an untrusted agent to do. In addition, the lack of a clock reduces the propagation of noise through the circuit.

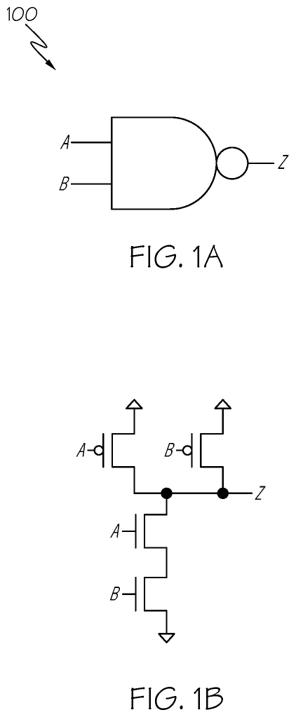

However, one of the drawbacks of NCL asynchronous circuit designs is the large area overhead required for asynchronous circuits that are logically equivalent to synchronous circuits. For example, FIG. 1A shows illustrates an example 2-input NAND gate 100 and FIG. 1B shows the circuit diagram for the NAND gate 100. As shown in FIG. 1A, the NAND gate 100 has 2 inputs A and B and a single output Z. As shown in FIG. 1B, the NAND gate 100 utilizes four metal oxide semi-conductor (MOS) field effect transistors (FETs).

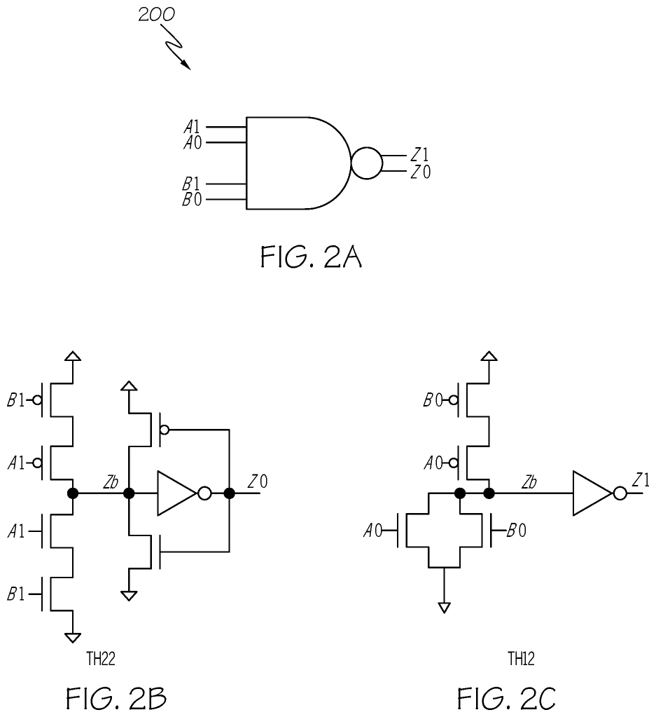

FIG. 2B, on the other hand, illustrates an NCL equivalent NAND gate 200, while FIGS. 2A and 2B illustrate the circuit diagram for implementing the NCL NAND gate 200. As shown in FIG. 2A, the NCL NAND gate 200 has a dual-rail input with wires A1 and A0, a dual-rail input with wires B1 and B0, and a dual-rail output with wires Z1 and Z0. FIG. 2B illustrates the circuit diagram for threshold gate TH22, which drives the low output Z0, while FIG. 2C illustrates the circuit diagram for threshold gate TH12, which drives the high output Z1. Between the two threshold gates TH22 and TH12 the NCL NAND gate 200 utilizes 14 FETs. In general, the circuits for NCL equivalent gates are typically 2.5 to 3.5 times the size of the circuits for their standard logic equivalent gates.

Due to the area overhead of NCL gates, the cost of asynchronous versions of standard circuits can be prohibitively expensive. In particular, one method of converting a synchronous circuit to an asynchronous circuit is to replace all or part of the gates in a standard circuit with NCL asynchronous equivalent gates. However, because of the increase in size of NCL asynchronous gates, as discussed above, this can greatly increase the size and cost of the asynchronous circuit compared to the synchronous circuit.

One approach to reduce the increased size of converting a synchronous circuit to an asynchronous circuit is to only replace gates along the critical path of the circuit. However, NCL gates require signal conditioning circuitry, which add delay to the arrival time of the input signals driving the logic gates. As such, replacing gates of a synchronous circuit along the critical path may result in a modified or different critical path. As such, it may be required to either replace all gates of a synchronous circuit with NCL gates, which results in a large increase in circuit size, or to continually determine a new critical path and re-design the asynchronous circuit accordingly, which is difficult to implement.

Accordingly, in embodiments disclosed herein, hybrid gates are disclosed. The hybrid gates disclosed herein include all required signal conditioning, and as such, do not increase combinational input delay or change the critical path of a circuit. As such, the hybrid gates disclosed herein can be used to replace only gates along the critical path of a synchronous circuit in order to convert the synchronous circuit to an asynchronous circuit.

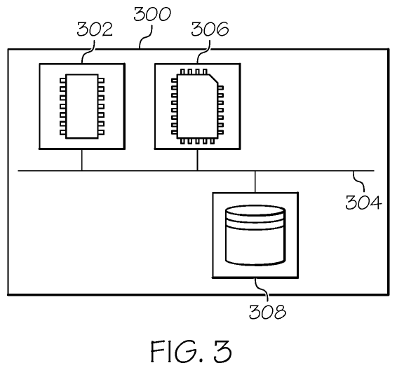

Turning now to FIG. 3, a schematic diagram of a computing device 300 is shown. The computing device 300 may be utilized to convert a synchronous circuit to an asynchronous circuit, as shown herein. As shown in FIG. 3, the computing device 300 includes a processor 302, a communication path 304, one or more memory modules 306, and a data storage component 308, the details of which will be set forth in the following paragraphs.

The processor 302 may be any device capable of executing machine readable and executable instructions. Accordingly, the processor 302 may be a controller, an integrated circuit, a microchip, a computer, or any other computing device. The processor 302 is coupled to a communication path 304 that provides signal interconnectivity between various modules of the computing device 300. Accordingly, the communication path 304 may allow the modules coupled to the communication path 304 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 304 may be formed from any medium that is capable of transmitting a signal such as, for example, conductive wires, conductive traces, optical waveguides, or the like. In some embodiments, the communication path 304 may facilitate the transmission of wireless signals, such as Wi-Fi, Bluetooth®, Near Field Communication (NFC) and the like. Moreover, the communication path 304 may be formed from a combination of mediums capable of transmitting signals. In one embodiment, the communication path 304 comprises a combination of conductive traces, conductive wires, connectors, and buses that cooperate to permit the transmission of electrical data signals to components such as processors, memories, sensors, input devices, output devices, and communication devices. Accordingly, the communication path 304 may comprise a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The computing device 300 includes one or more memory modules 306 coupled to the communication path 304. The one or more memory modules 306 may comprise RAM, ROM, flash memories, hard drives, or any device capable of storing machine readable and executable instructions such that the machine readable and executable instructions can be accessed by the processor 302. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 306. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The computing device 300 comprises a data storage component 308. The data storage component 308 may store data used by various components of the computing device 300. In addition, the data storage component 308 may input data relating to synchronous circuits to be converted to asynchronous.

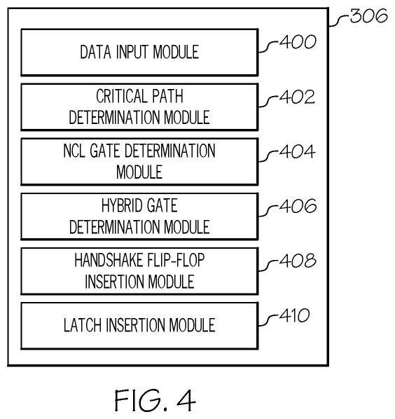

Now referring to FIG. 4, the memory modules 306 of the computing device 300 are schematically shown. The memory modules 306 include a data input module 400, a critical path determination module 402, an NCL gate determination module 404, a hybrid gate determination module 406, a handshake flip-flop insertion module 408, and a latch insertion module 410. Each of the data input module 400, the critical path determination module 402, the NCL gate determination module 404, the hybrid gate determination module 406, the handshake flip-flop insertion module 408, and the latch insertion module 410 may be a program module in the form of operating systems, application program modules, and other program modules stored in the one or more memory modules 306. Such a program module may include, but is not limited to, routines, subroutines, programs, objects, components, data structures and the like for performing specific tasks or executing specific data types as will be described below.

The data input module 400 receives data about a synchronous circuit to be converted to an asynchronous circuit. In particular, the data input module 400 receives data indicating a circuit design for a synchronous circuit. In the illustrated example, the data input module 400 receives a structural Verilog netlist indicating a circuit design for a synchronous circuit. However, in other examples, the data input module 400 may receive data about a synchronous circuit in other formats.

In embodiments the circuit design received by the data input module 400 comprises a plurality of logic gates. The computing device 300 may generate a modified circuit design that replaces a subset of the logic gates of the input circuit with hybrid gates, as disclosed herein.

Referring still to FIG. 4, the critical path determination module 402 determines the critical delay path through all combinational subcircuit blocks of the circuit design received by the data input module 400. This may be accomplished using a variety of known techniques. In particular, the critical path determination module 402 may determine the critical path by performing an O(N·log(N)) breadth first search, where N is the number of nodes in a graph representing the combinational circuit.

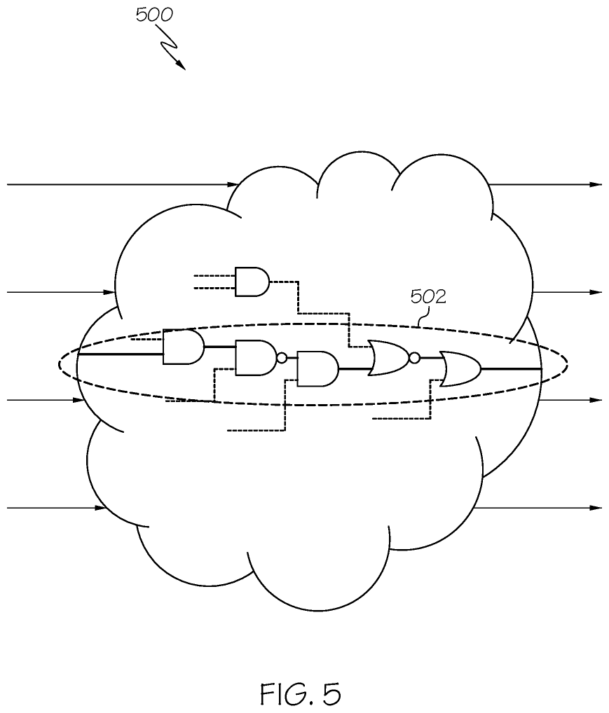

FIG. 5 shows a portion of an example circuit 500 having combinational logic comprising a plurality of logic gates. The critical path 502 of the circuit 500 is illustrated in FIG. 5. Accordingly, for the example circuit 500 of FIG. 5, the critical path determination module 402 may identify the critical path 502, and the computing device 300 may replace the logic gates in the critical path 502 with hybrid gates, as disclosed in further detail below. By only replacing gates in the critical path with hybrid gates, a minimum number of gates are replaced, thereby minimizing the increase in the size of the resulting asynchronous circuit.

Referring back to FIG. 4, the NCL gate determination module 404 may determine the NCL equivalent gate for each logic gate in the critical path identified by the critical path determination module 402. In embodiments, the NCL gate determination module 404 may use direct replacement or other known techniques to determine the NCL equivalent gate for each logic gate in the identified critical path.

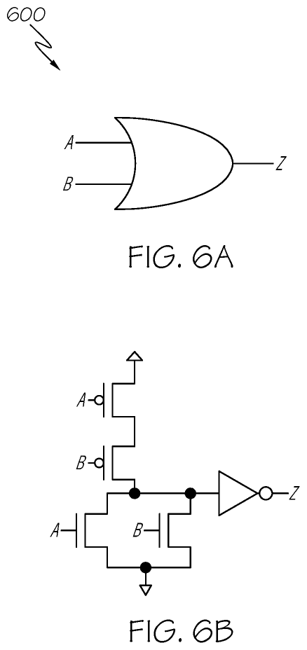

FIG. 6A shows a standard 2-input OR gate 600, and FIG. 6B shows the circuit design for the OR gate 600. As shown in FIG. 6A, the OR gate 600 has two Boolean input signals, A and B, and a single Boolean output signal Z. Each signal A, B, and Z can have a Boolean value of logic ‘1’ or logic ‘0’.

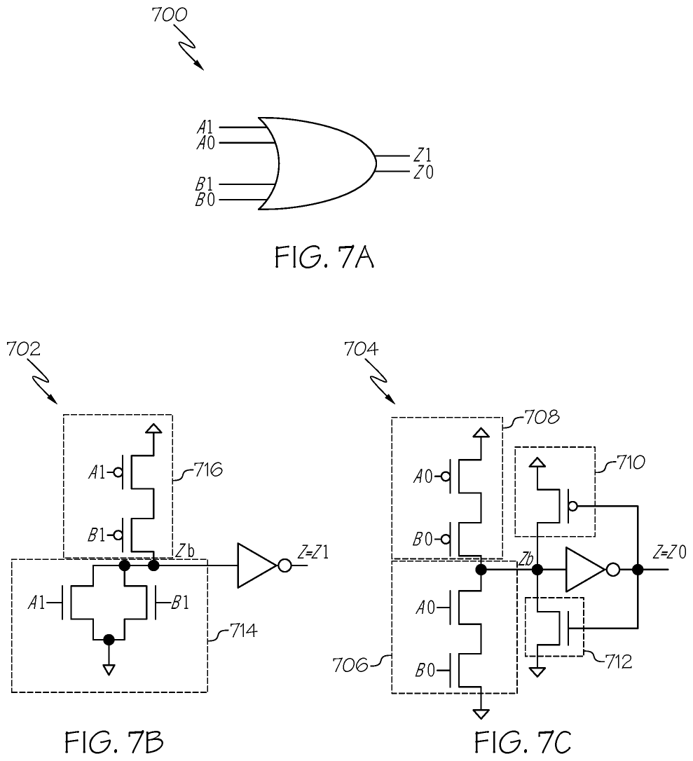

FIG. 7A shows the NCL equivalent OR gate 700. As shown in FIG. 7A, the OR gate 700 includes two dual-rail input signals, A (A1 and A0 wires) and B (B1 and B0 wires), and one dual-rail output signal Z (Z1 and Z0 wires). Each dual-rail signal has two wires, a logic ‘1’ and a logic ‘0’, which are driven by two subcircuits. FIG. 7B shows a first subcircuit or threshold gate 702 for driving the high output Z1, and FIG. 7C shows a second subcircuit or threshold gate 704 for driving the low output Z0.

An NCL threshold gate comprises four networks, a first network to set Z, a second network to reset Z, a third network to hold Z at Vss, and a fourth network to hold Z at Vdd. In the example of FIG. 7C, the threshold gate 704 comprises a first network 706 to set Z, a second network 708 to reset Z, a third network 710 to hold Z at Vss, and a fourth network 712 to hold Z at Vdd. In the example of FIG. 7B, threshold gate 702 comprises a first network 714 to set Z and a second network 716 to reset Z. However, for the threshold gate 702, a third network to hold Z at Vss and a fourth network to hold Z at Vdd are not needed.

Referring back to FIG. 4, the hybrid gate determination module 406 may replace each gate in the critical path determined by the critical path determination module 402 with a hybrid gate, as disclosed herein. For a reliable asynchronous circuit, replacing Boolean logic gates in the critical path with hybrid equivalent gates must not change the critical path. As a result of this assertion, all non-critical path (standard Boolean) signal values arrive at critical path hybrid gate inputs before the critical path asynchronous NCL signals.

The hybrid gates disclosed herein have two types of inputs, a standard Boolean input, and a dual-rail asynchronous NCL input. Since the hybrid gates are creating an asynchronous path through a combination block, they only have a dual-rail asynchronous output. Thus, except for rare cases like certain combinational block inputs, a hybrid gate only has a single dual-rail NCL input, and the other inputs will be standard Boolean inputs. For a standard 2-input gate, a hybrid equivalent gate will have one dual-rail NCL input and one Boolean input. For a standard 3-input gate, a hybrid equivalent gate will have one dual-rail NCL input and two Boolean inputs. For standard gates with additional inputs, a hybrid equivalent gate will have additional Boolean inputs.

To ensure that the above assertion is adhered to, a hybrid gate must require no external signal conditioning on its inputs and the hybrid gate design must guarantee signal propagation delay through the hybrid gate that is greater than or equal to the delay through the Boolean gate it is replacing. This is typically not an issue since the hybrid gates have at least two levels of transistor delay and additional delay can be added by carefully sizing the transistors. However, this should be verified before fabrication or implementation.

As discussed above, to avoid the required signal conditioning of NCL gates to change the critical path of a circuit, the disclosed hybrid gates include signal conditioning. As such, a hybrid gate can be directly inserted into a critical path. Its single dual-rail NCL input may directly interface to the NCL output of the previous hybrid gate in the critical path. If a hybrid gate is the first gate in the critical path, its NCL input is fed by an NCL register cell. Its other (non-NCL) Boolean inputs are driven by the outputs of non-critical path Boolean gates. The single NCL output of a hybrid gate drives the NCL input of the next hybrid gate in the critical delay path.

Referring to the example NCL OR gate 700 of FIGS. 7A-7C, a DATA (Vdd) value applied to either a logic ‘1’ wire or a logic ‘0’ wire asserts its logic value. In other words, a Vdd applied to a logic ‘1’ wire implies the NCL signal has a logic ‘1’, and a Vdd applied to the logic ‘0’ wire implies a logic ‘0’ value on the NCL signal. Thus, the disclosed hybrid gates are able to support both single rail Boolean inputs and asynchronous dual-rail NCL input and output.

The difficult part of the design of a hybrid gate is handling a Boolean logic ‘0’ input. Since the hybrid gate output is a dual-rail NCL output signal, a logic'0′ value is represented by a Vdd voltage level on the logic ‘0’ wire. As such, hybrid gates need to process Boolean logic ‘0’ inputs and generate Vdd voltage levels on NCL logic ‘0’ output wires. Traditional CMOS gate design does not work because it requires inverting logic ‘0’ Boolean signal values, and the extra inversion can change the circuit critical path. To handle this, unconventional, weak transistor design is leveraged.

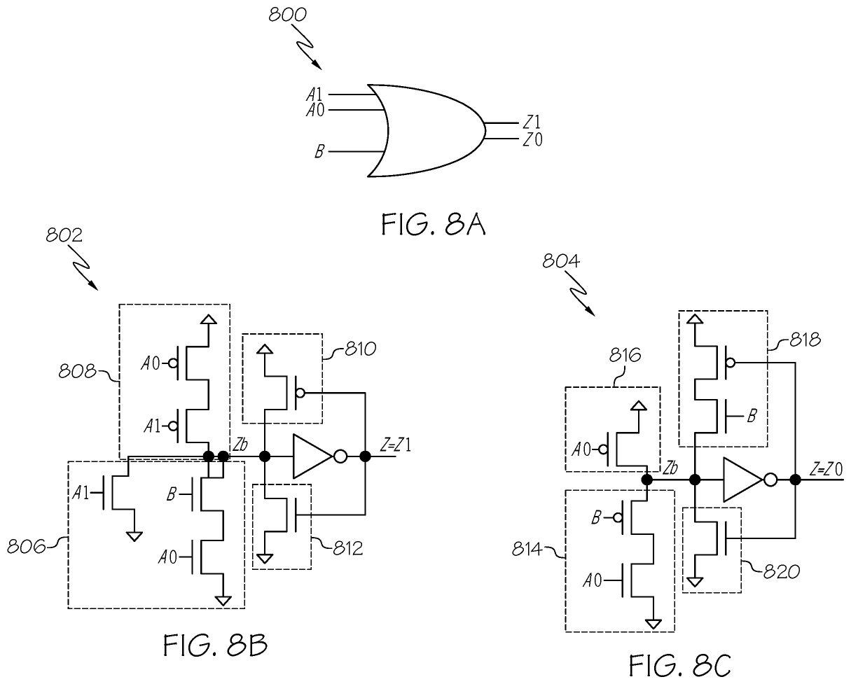

FIG. 8A shows an example hybrid OR gate 800 that may be determined by the hybrid gate determination module 406, while FIGS. 8B and 8C show the subcircuits of the example OR gate 800. In particular, FIG. 8B shows subcircuit 802 of the hybrid OR gate 800 for driving the high output Z1, and FIG. 8C shows subcircuit 804 of the hybrid OR gate 800 for driving the low output Z0. The hybrid OR gate 800 of FIGS. 8A-8C has a dual-rail input (wires A1 and A0), a Boolean input B, and a dual-rail output (wires Z1 and Z0).

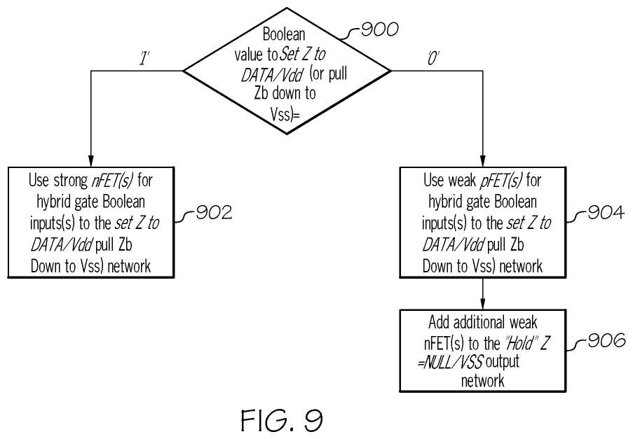

FIG. 9 shows a flowchart of a method that may be performed by the hybrid gate determination module 406 to determine the design for a hybrid gate. In particular, the method of FIG. 9 converts an NCL gate determined by the NCL gate determination module 404 into a hybrid gate. Thus, the hybrid gate determination module 406 utilizes the method of FIG. 9 to analyze a particular NCL gate determined by the NCL gate determination module 404 to convert that particular NCL gate into a hybrid gate. The method of FIG. 9 may be performed by the hybrid gate determination module 406 for each gate in the critical path identified by the critical path determination module 402. In particular, the method of FIG. 9 may be performed to modify both threshold gates of an NCL gate.

At step 900, the hybrid gate determination module 406 determines whether the set Z to Vdd network of the NCL gate includes a B1 input or a B0 input. If the set Z to Vdd network of the NCL gate includes a B1 input, then at step 902, the B1 input is replaced with a B input going into a strong N-type transistor (nFET). Alternatively, if the set Z to Vdd network of the NCL gate includes a B0 input, then at step 904, the B0 input is replaced with a B input going into a weak P-type transistor (pFET). Then, at step 906, an additional weak nFET with a B input is added to the Hold Z at Vss network.

The reset network of the resulting hybrid gate is then modified to conform to the modified set Z network using known techniques. For example, if we use both A0 and Al in the set Z network of the hybrid gate, then the reset Z network of the hybrid gate should include both A0 and A1 in series. Then a NULL value on both A0 and A1 at the same time will reset Z to a NULL value. If the set Z network of the hybrid gate only contains A0 (or A1), then the reset Z network of the hybrid gate only needs A0 (or A1). In this case, you only need a NULL value on A0 (or A1) to reset Z to NULL. This is true regardless of whether or not weak transistors are used in the set Z networks. The hold Z at Vdd network of the hybrid gate remains unchanged from the hold Z at Vdd network of the NCL equivalent gate.

The hybrid gate determination module 406 may utilize the method of FIG. 9 to determine the design of any type of logic gate. However, for purposes of illustration, the method is discussed in detail with respect to the design of an OR gate. In particular, the method of FIG. 9 may be used to convert the NCL OR gate 700 of FIGS. 7A-7C to the hybrid OR gate 800 of FIGS. 8A-8C.

For the threshold gate 702 of FIGS. 7B, at step 900 of FIG. 9, the hybrid gate determination module 406 determines that the set Z network 708 includes input B1. As such, control proceeds to step 902 and the B1 input of the set Z network 708 is replaced with a B input going into a strong nFET in the set Z network 806 of the threshold gate 802 of FIG. 8B.

In addition, an A0 input is added to the set Z network so that the hybrid gate won't assert itself until either A0 or A1 has a DATA value on it. In particular, the A1 or the A0 signal values are the last to arrive in the hybrid gate since A1 and AO are in the critical path. The values for all other (standard) logic signals B, C, D, etc., arrive before the values on A1 and A0. In operation, the hybrid gate should not switch until a DATA value arrives at A1 or A0. In the example of FIG. 7B, either a DATA value on A1 or a logic value ‘1’ on B and DATA value on A0 will cause the assertion on the hybrid gate. If A0 is not included, the hybrid gate may assert itself when B arrives.

For the threshold gate 704 of FIG. 7C, at step 900 of FIG. 9, the hybrid gate determination module 406 determines that the set Z network 706 includes input B0. As such, control proceeds to step 902 and the B0 input of the set Z network is replaced with a B input going into a weak pFET in the set Z network 814 of the threshold gate 804 of FIG. 8C. Then, control proceeds to step 904 and a weak nFET with a B input is added to the hold Z at VSS network 818 of FIG. 8C. Operation of the hybrid gate of FIGS. 8A-8C is discussed below.

For the OR gate of FIGS. 8A-8C, there are three critical cases to analyze: A=‘1’→Z=‘a’, B=‘1’→Z=‘1’, and A=B=‘0’→Z=‘0’. For the A=‘1’ case, output Z should become a logic ‘1’ regardless of the value on the Boolean input B. In asynchronous NCL, this corresponds to DATA (Vdd) on the logic ‘1’ wire Z1, and a NULL (Vss) on the logic ‘0’ wire Z0. Since the NCL input signal A is in the critical path the dual-rail NCL wire A1 will become Vdd after the arrival of the value on Boolean input B (which is a don't care for this case). Since A1 becomes Vdd, according to NCL convention, A0 will remain Vss. In the example of FIGS. 8A-8C, with A1=Vdd, Z1 will be set to Vdd, and with A0=Vss, Z0 will stay at Vss. Further, Z1 sill remain Vdd (hysteresis) until A1 is reset to Vss.

For the B=‘1’ case, output Z should go to a logic ‘1’ regardless of the value that the NCL input signal A eventually becomes. In the new data-path approach, B becomes ‘1’ and then either A1 or A0 will become DATA (Vdd) while the other remains NULL (Vss). In the example of FIGS. 8A-8C, if A1=Vdd (A0=Vss), the lobic ‘1’ output wire Z1 will be Vdd, and the logic ‘0’ output wire Z0 will be Vss. Otherwise, if A0=Vdd (A1=Vss), the logic ‘1’ output wire Z1 will become Vdd and the logic ‘0’ output wire Z0 will remain Vss. So the logic ‘1’ output wire Z1 is set regardless of the value signal A becomes. Furthermore, Z1 will remain Vdd until A is reset (A1=A0=Vss).

It should be noted that for both of the previous cases, the Boolean input is either a logic ‘1’ or a don't care For the final case, where the Boolean signal has a controlling value of ‘0’, the pFET design flow of the method of FIG. 9 comes into play.

For the A=B=‘0’ case in the example of FIGS. 8A-8C, the output should eventually become a logic ‘0’. For NCL, both A1 and A0 are initialized to NULL (Vss). In the example OR gate of FIGS. 8A-8C, these NULL values force Z1=Z0=Vss regardless of the value on Boolean input B. Based on the data-path assertios, B becomes ‘0’ before A is asserted. With B=‘0’, when A0 is asserted to Vdd (A1 is still Vss), Z1 will remain Vss, however, Zb in the Z0 subcircuit will be pulled down through the weak B pFET, and Z0 will become Vdd. As such, the logic ‘0’ output wire Z0 is set. Furthermore, Z0 will remain set to Vdd until A is reset (A1=A0=Vss).

To satisfy the assertion that the hybrid equivalent gates not change the critical path, the propagational delay of a hybrid gate must be greater than or equal to the delay of the replaced Boolean gate. Given the assertion is true, it can be safely assumed that all Boolean combinational signal values arrive before the NCL dual-rail signal values. To guarantee the assertion, designers can carefully control hybrid gate transistor sizing. One simple approach is to start with standard proportional transistor widths for the nMOS and pMOS transistors in the hybrid gates and performing Spice simulations to compare propagation delays between the Boolean logic gates and their hybrid replacements. The widths of the hybrid gate transistors can be adjusted to increase the hybrid propagation delay (delay between NCL dual-rail input change and corresponding dual-rail output change) to a percent difference that guarantees reliable operation for the envelope of a particular target technology fabrication node.

Referring back to FIG. 4, the handshake flip-flop insertion module 408 may replace flip-flops that drive the asynchronous NCL inputs of the hybrid gates (e.g., inputs A1 and A0 of FIGS. 8A-8C) as determined by the hybrid gate determination module 406 with their NCL asynchronous equivalents. The latch insertion module 410 may replace the remaining flip-flops flip-flops of the gates not in the critical path with low overhead latches controlled by NCL asynchronous handshaking.

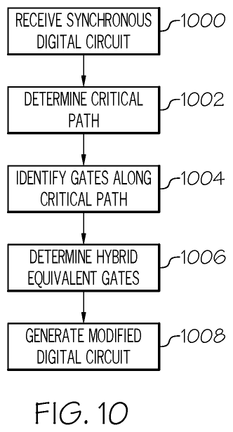

FIG. 10 depicts a flowchart of an example method that may be performed by the computing device 300 to convert a synchronous circuit to an asynchronous circuit. At step 1000, the data input module 400 receives information about synchronous digital circuit. In particular, the data input module 400 receives a circuit diagram of a synchronous circuit that is to be converted to an asynchronous circuit. In some examples, the data input module 400 may receive a structured Verilog netlist.

At step 1002, the critical path determination module 402 determines a critical path through each synchronized, combination subcircuit block of the digital circuit received by the data input module 400. In some examples, the critical path determination module 402 may determine the critical paths by performing a breadth first search of the digital circuit. At step 1004, the critical path determination module 402 identifies all the Boolean gates along the determined critical paths.

At step 1006, the hybrid gate determination module 406 determines hybrid equivalent gates for all the gates along the identified critical paths. In the illustrated example, the NCL gate determination module 404 first determines NCL equivalent gates for all of the gates along the determined critical paths. Then, the hybrid gate determination module 406 converts the NCL equivalent gates to hybrid gates using the method of FIG. 9.

At step 1008, the hybrid gate determination module 406 generates a modified digital circuit by replacing the Boolean gates along the determined critical paths with the determined hybrid gates. The handshake flip-flop insertion module 408 may then replace the flip-flops that drive the asynchronous inputs of the hybrid equivalent gates with null convention logic asynchronous gates. The latch insertion module 410 may then replace the other flip-flops with latches to complete the modified digital circuit. The resulting modified digital circuit is an asynchronous equivalent of the received synchronous circuit.

To test the disclosed embodiments, two asynchronous versions of a plurality of benchmark circuits was generated. A first set of asynchronous circuits was generated by replacing all standard Boolean gates of the benchmark circuits with NCL equivalents. A second set of asynchronous circuits was generated using the disclosed method of replacing only the gates along the critical paths with hybrid gates.

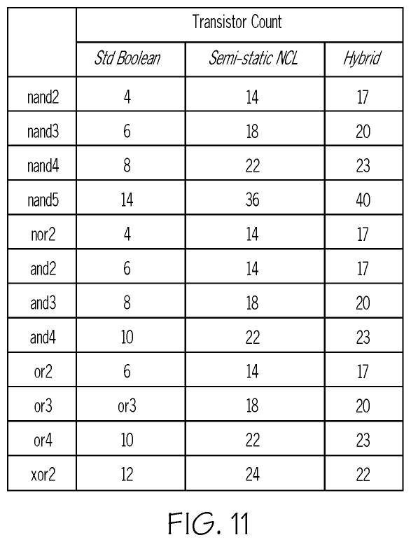

FIG. 11 shows a table of the transistor counts for various standard Boolean gates, as well as their semi-static NCL and hybrid equivalents. While the hybrid equivalent gates have similar transistor counts to the semi-static NCL gates, in the disclosed method, only the standard gates along the critical paths need to be replaced with hybrid gates, while the gates not along the critical paths remain as standard Boolean gates.

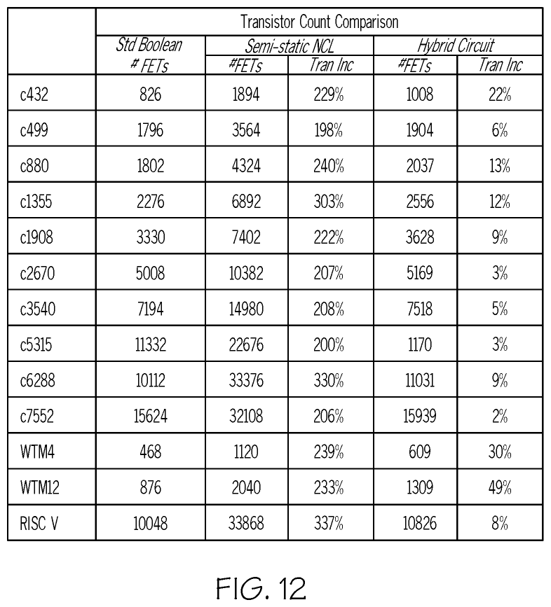

FIG. 12 shows the number of FETs required for a plurality of benchmark circuits using standard Boolean gates, using Semi-static NCL gates to replace all Boolean gates, and using the disclosed hybrid circuit with only critical path gates replaced with hybrid gates. FIG. 12 also shows the percentage increase in transistors needed for the Semi-static NCL circuits and for the disclosed hybrid circuits. As can be seen in FIG. 12, the disclosed hybrid circuits require significantly less transistors than the Semi-static NCL circuits. On average, the number of transistors needed for the NCL semi-static version of the benchmark circuits was 2.47 times the size of the standard Boolean circuits. However, the number of transistors needed for the disclosed hybrid circuits was on average only 6% larger than the standard Boolean circuits.

It should now be understood that embodiments described herein are directed to an area efficient asynchronous circuit generator. The disclosed method is based on replacing standard Boolean gates in a digital circuit with hybrid gates having a dual-rail asynchronous NCL input and one or more standard Boolean inputs. A key advantage of the disclosed hybrid gates is that all signal conditioning required to convert standard Boolean inputs to asynchronous inputs is included within the hybrid gate. As such, no additional signal conditioning required. This trait, along with controlled delay, ensures that the critical path will remain intact when the hybrid gates are inserted.

The disclosed method can convert synchronous circuits to asynchronous circuits in a systematic manner using the methods disclosed herein. The resulting asynchronous circuits are only slightly larger than standard Boolean circuits. As such, the asynchronous circuits generated using the disclosed techniques are smaller and less expensive than asynchronous circuits generated using other methods.

1. An apparatus comprising a controller programmed to:
receive information about a synchronized digital circuit comprising a plurality of Boolean gates;
determine a critical path through each synchronized, combination subcircuit block of the digital circuit;
identify a first set of Boolean gates among the plurality of Boolean gates positioned in the critical path;
determine a hybrid equivalent gate for each Boolean gate among the first set of Boolean gates, wherein the hybrid equivalent gate has a synchronous input, a dual-rail asynchronous input, and a dual-rail output; and
generate a modified digital circuit by replacing each Boolean gate among the first set of Boolean gates with a corresponding hybrid equivalent gate.

2. The apparatus of claim 1, wherein the information about the synchronized digital circuit comprises a structural Verilog netlist.

3. The apparatus of claim 1, wherein the controller is programmed to determine the critical path by performing a breadth first search.

4. The apparatus of claim 1, wherein the controller is programmed to generate the modified digital circuit by:
replacing flip-flops in the digital circuit that drive asynchronous inputs of the hybrid equivalent gates with null convention logic asynchronous equivalents; and
replacing flip-flops in the digital circuit that do not drive the asynchronous inputs of the hybrid equivalent gates with latches controlled by asynchronous handshaking.

5. The apparatus of claim 1, wherein the controller is programmed to determine the hybrid equivalent gate by, for each gate:
determining an NCL equivalent gate having a first dual-rail input with wires A1 and A0, a second dual-rail input with wires B1 and B0, a dual-rail output with wires Z1 and Z0, a first subcircuit associated with Z1, and a second subcircuit associated with Z0;
determining, for the first subcircuit and the second subcircuit, whether a set Z network a B1 input or a B0 input;
upon determination that the set Z network includes a B1 input, replacing the B1 input with a synchronous B input connected to a strong nFET; and
upon determination that the set Z network includes a B0 input, replacing the B0 input with a synchronous B input connected to a weak pFET, and adding a synchronous B input connected to a weak nFET to a hold Z at Vss network.

6. The apparatus of claim 5, wherein the controller is programmed to determine the hybrid equivalent gate by, for the first subcircuit and the second subcircuit, modifying a reset network to conform to the set Z network.

7. The apparatus of claim 1, wherein the critical path through each synchronized, combination subcircuit block of the digital circuit is the same as a critical path through each combination subcircuit block of the modified digital circuit.

8. The apparatus of claim 1, wherein a propagational delay of each hybrid equivalent gate is greater than or equal to a delay of each Boolean gate of the first set of Boolean gates.

9. A method comprising:
receiving information about a synchronized digital circuit comprising a plurality of Boolean gates;
determining a critical path through each synchronized, combination subcircuit block of the digital circuit;
identifying a first set of Boolean gates among the plurality of Boolean gates positioned in the critical path;
determining a hybrid equivalent gate for each Boolean gate among the first set of Boolean gates, wherein the hybrid equivalent gate has a synchronous input, a dual-rail asynchronous input, and a dual-rail output; and
generating a modified digital circuit by replacing each Boolean gate among the first set of Boolean gates with a corresponding hybrid equivalent gate.

10. The method of claim 9, wherein the information about the synchronized digital circuit comprises a structural Verilog netlist.

11. The method of claim 9, further comprising determining the critical path by performing a breadth first search.

12. The method of claim 9, further comprising generating the modified digital circuit by:
replacing flip-flops in the digital circuit that drive asynchronous inputs of the hybrid equivalent gates with null convention logic asynchronous equivalents; and
replacing flip-flops in the digital circuit that do not drive the asynchronous inputs of the hybrid equivalent gates with latches controlled by asynchronous handshaking.

13. The method of claim 9, further comprising determining the hybrid equivalent gate by, for each gate:
determining an NCL equivalent gate having a first dual-rail input with wires A1 and A0, a second dual-rail input with wires B1 and B0, a dual-rail output with wires Z1 and Z0, a first subcircuit associated with Z1, and a second subcircuit associated with Z0;
determining, for the first subcircuit and the second subcircuit, whether a set Z network a B1 input or a B0 input; and
upon determination that the set Z network includes a B1 input, replacing the B1 input with a synchronous B input connected to a strong nFET.

14. The method of claim 9, further comprising determining the hybrid equivalent gate by, for each gate:
determining an NCL equivalent gate having a first dual-rail input with wires Al and A0, a second dual-rail input with wires B1 and B0, a dual-rail output with wires Z1 and Z0, a first subcircuit associated with Z1, and a second subcircuit associated with Z0;
determining, for the first subcircuit and the second subcircuit, whether a set Z network a B1 input or a B0 input; and
upon determination that the set Z network includes a B0 input, replacing the B0 input with a synchronous B input connected to a weak pFET, and adding a synchronous B input connected to a weak nFET to a hold Z at Vss network.

15. The method of claim 13, further comprising determining the hybrid equivalent gate by, for the first subcircuit and the second subcircuit, modifying a reset network to conform to the set Z network.

16. The method of claim 14, further comprising determining the hybrid equivalent gate by, for the first subcircuit and the second subcircuit, modifying a reset network to conform to the set Z network.

17. The method of claim 9, wherein the critical path through each synchronized, combination subcircuit block of the digital circuit is the same as a critical path through each combination subcircuit block of the modified digital circuit.

18. The method of claim 9, wherein a propagational delay of each hybrid equivalent gate is greater than or equal to a delay of each Boolean gate of the first set of Boolean gates.

19. A digital circuit comprising:
a plurality of Boolean gates, wherein each gate among a first set of Boolean gates along a critical path through each synchronized, combination subcircuit block of the digital circuit comprises a hybrid equivalent gate, wherein the hybrid equivalent gate has a synchronous input, a dual-rail asynchronous input, and a dual-rail output.

20. The digital circuit of clam 19, wherein:
null convention logic asynchronous equivalent flip-flops drive the asynchronous inputs of the hybrid equivalent gates; and
latches controlled by asynchronous handshaking drive the synchronous inputs of the hybrid equivalent gates.
